(19) United States
(12) Patent Application Publication
(10) Pub. No.: US 2026/0135780 A1
(43) Pub. Date: May 14, 2026

(54) METHOD, APPARATUS AND SYSTEM FOR A USER TO CONTROL NETWORK SERVICES BY A VIRTUAL USER EQUIPMENT

(71) Applicant: Huawei Technologies Co., Ltd., Shenzhen (CN)

(72) Inventors: Nimal Gamini Senarath, Ottawa (CA); Mehdi Arashmid Akhavain Mohammadi, Nepean (CA)

(21) Appl. No.: 19/441,143

(22) Filed: Jan. 6, 2026

Related U.S. Application Data
(63) Continuation of application No. PCT/CN2023/106032, filed on Jul. 6, 2023.

(51) Int. Cl. H04L 41/40; H04L 41/50; H04W 48/18; H04W 88/04

(52) U.S. Cl. CPC H04L 41/40; H04W 48/18; H04L 41/50; H04W 88/04

(57) ABSTRACT

This application is directed to a method, an apparatus, and a system to, for example, enable a user to interact, manage, and control certain aspects of its own traffic by providing the user with controllable network functions and associated interfaces within the mobile network architecture. In an example method for a user equipment (UE) to control a network service obtained from a network, a control, management, and operation (CMO) function module instantiated in the network may receive from the UE, a request for the UE to control the network service offered by the network. In response to the request, the CMO function module can instantiate at least one network function (NF) configured to be controlled by the UE. The CMO function module can further configure the at least one NF to control the network service in accordance with instructions received from the UE.

### CROSS-REFERENCE TO RELATED APPLICATIONS

This application is a continuation of International Application No. PCT/CN 2023/106032, filed on Jul. 6, 2023, the disclosure of which is hereby incorporated by reference in its entirety.

### TECHNICAL FIELD

The present disclosure pertains to a field of data communications and, in particular, to a method, an apparatus, and a system to enable a user equipment (UE) to interact, manage, and control certain aspects of the user's own traffic, including the network services provided by the network.

### BACKGROUND

Public land mobile networks (PLMNs) are designed to provide connectivity services to users and UEs. The concept of user centric networks (UCNs) improves user network experience by dynamically adapting a network structure to individual user contexts, such as UE location or mobility conditions. An example of a UCN service is a ‘free cell’ structure formed by a group of wireless access points (APs). In the free cell, a set of access points may be dynamically selected based on a location of a UE and changed according to the user's UE mobility path or conditions.

Future networks may become more and more ‘user-centric’ as users require/demand more ownership and control over their services, i.e., these future networks are expected to provide increased user empowerment. UCNs may be designed in a way for a user, through their UE, to have more control over services provided by a network or more control over the network providing these services to the user. Current UCN designs may be configured to capture and adapt to individual UE contexts, such as the location and the mobility of an individual UE.

In communication networks, a UE is treated as a separate entity that requires connectivity services from the network. UE may also assist the network to improve UE's communications services or network operations, either through providing data to the network or by acting as a part of the network infrastructure (e.g., as a relay). The UE's involvement in the UCN operation constitutes a branch of the UCN services, and these user empowerment services are termed User Controlled and Managed services (UCM services) in this document.

Traditional UE may be viewed as having two parts: the network access device (NAD), which has network access components, and a user personal device (UPD), which has components (both software and hardware) that are used to process user applications and personal data. While the UPD may have personal data of UE operators (users), the NAD is considered isolated from the personal data. However, certain NAD information, such as the NAD location and the NAD's sensor data, may still be considered as the user equipment operator's personal data. In the context of the present disclosure, the term UE refers to both the UPD and the NAD.

In conventional networks, a UE can only select services from a predetermined set of communication service types (e.g., URLLC, Video service with specific quality, etc.), the set of communication services being defined by the network. And the UE cannot control or manage how the network behaves or how the UE's traffic could be facilitated.

In 5G networks, it may be possible to engage a complete network slice for a dedicated UE by acting as a vertical such as enterprise. However, such slices in the 5G networks are costly and would be wasteful when used for a single UE, and even in this case, the UE cannot control the network services, instead, the UE can select a certain type of slice for its exclusive use.

Therefore, improvements in communication networks are desirable.

This background information is provided to reveal information believed by the applicant to be of possible relevance to the present disclosure. No admission is necessarily intended, nor should it be construed, that any of the preceding information constitutes prior art against the present disclosure.

### SUMMARY

In the context of the present disclosure the expression ‘user-centric management and control (UCM)’ services is used to indicate the services that can be offered by networks to control and manage the user services according to the present disclosure. A proposed UCN design type facilitates the ability of a UE to control services and their features provided by a network, or to manage the network components that provide these services and features to the UE. These services are termed user controlled and managed (UCM) services in the context of the present disclosure.

The present disclosure relates to embodiments of a method, an apparatus and a system configured to provide UEs with different types of UCM services and features or user empowerment levels through instantiation of a UE controllable network function inside a network while preserving the UE operator's privacy. As this UE controllable network function can act on behalf of the UE to closely interact with the functions in the network, the term Virtual UE (VUE) may be used for this functionality.

Embodiments of the present disclosure are directed to a method, an apparatus, and systems configured to enable UEs to interact, manage, and control certain aspects of their own traffic by providing a UE with controllable network functions and associated interfaces within a mobile network architecture. Different network functions, for example control plane functions (CPFs), data plane functions (DPFs), data storage functions, and computing resources functions, may be provided by different types of VUEs. Some functionalities of these network functions may include interactions with a UE to obtain the UE context and data, authentication of the UE and authorization on behalf of the UE, interactions with the network to control certain aspects of the UE traffic or to obtain the UE traffic for internal processing, storing data when the UE is not online, firewall functions for the UE traffic and sharing the UE data with the network preserving privacy.

In a first aspect, the present disclosure provides a method for a user equipment (UE) to control a network service obtained from a network. The method comprises, by a control, management, and operation (CMO) function module instantiated in the network: receiving, from the UE, a request for the UE to control the network service offered by the network. The method further comprises, in response to the request, instantiating at least one network function (NF) configured to be controlled by the UE; and configuring the at least one NF to control the network service in accordance with instructions received from UE.

In some embodiments, the method of the first aspect may further comprise, by the CMO function module, indicating to the UE that the UE controls the network service.

In some embodiments, the method of the first aspect may also comprise, by the CMO function module: instantiating a NF module defining a virtual UE (VUE), the VUE comprising the at least one NF.

In some embodiments, the UE may be controlled by a user at the UE or a user application running at the UE, and at least one of the at least one NF may be configured to receive instructions from the UE in accordance with input provided by the user at the UE or by a user application running at the UE.

In some embodiments, the at least one NF may be configured to coordinate with the CMO function module to control the network service.

In some embodiments the network may be configured to do at least one of: provide to the UE, software configured to communicate with the VUE; provide authentication keys to the UE and to the VUE to enable secure communication between the UE and the VUE; provide a procedure for the UE to control the network service, the procedure defining how to establish a communication session for the network service; provide identifiers to be used by the CMO function module to identify messages associated to a control of the network service; and provide addresses of functions with which the UE has to communicate to control the network service.

In some embodiments, the network may comprise a trusted execution environment (TEE) within which the VUE operates. The VUE may be isolated from the network and permission to access the at least one network function and data inside the TEE is controlled by the VUE according to an access policy. Once a VUE is installed inside a TEE, the access to VUE is provided to the UE and even the network functions or the operator cannot access the VUE data or functions without the VUE or UE authorization.

In some embodiments, the VUE may have at least one VUE policy that defines how the VUE and the at least one network function operate. The at least one VUE policy may be based on one or more of: a UE policy set by a user of the UE or by a user application running at the UE; privacy schemes provided by the network; an access policy defining the permission to access the functions and data inside the VUE; and network environment information. The network environment information may be comprised of one or more of: network privacy preserving methods; information about network functions inside the CMO function module; a network topology; and a charging method to charge for network services.

In some embodiments, the CMO function module includes a VUE creation function (VUCF); and the request for the UE to control the network service is received at the VUCF and provided by the VUCF to an orchestrator configured to generate the VUE.

In some embodiments, the CMO function module may include a life cycle management (LCM) function configured to: request the instantiation, modification and termination of the VUE from an orchestrator; and receive, from the orchestrator, a message indicating to the VUE that the request has been executed.

In some embodiments, at least one of the at least one NF may be configured to coordinate with the VUE and take actions in accordance with requests made by the VUE to control the network service.

In some embodiments, the UE may obtain a network service, establish a communication session related to the network service and send a control instruction to the VUE to modify the network service.

In some embodiments, the at least one NF may be configured to operate as at least one of: a control plane function; a user plane function; a data storage function; and a computing facilities function.

In some embodiments, the at least one NF in cooperation with other NFs may be configured to do at least one of: authenticate the UE; authorize on behalf of the UE; interact with the UE to obtain a user context; control the user traffic; obtain the user traffic for internal processing; control access to the at least one NF and data associated with the VUE; interact with the UE to obtain user data; store at least a portion of the user data; share at least a part of the user data with the network; and manage the at least one NF. In some embodiments the other NFs are part of the VUE. In some embodiments, the other NFs are not part of the VUE but may be part of the CMO module or may be in the other entities of the core network.

In some embodiments, the UE, through the VUE, controls the network service, and the network service may include at least one of: a UE traffic service based on a user traffic policy; a data processing service of data associated with the UE; and a life cycle management (LCM) service of the at least one NF inside the CMO function module, the LCM service including at least one of an instantiation of the at least one NF, a scaling of NF resources used by the at least one NF and a termination of the at least one NF.

In some embodiments, the network may comprise a core network having core NFs, and the VUE is configured to control the core NFs, the core NFs including at least one of: a routing function, a data processing function and a traffic forwarding function.

In a second aspect, the present disclosure provides a network node having a control, management and operation (CMO) function module defined thereat, the network node being part of a network, the network node comprising: a processor; and a tangible, non-transitory memory having recorded thereon instructions to be carried out by the processor to carry out a method for a user equipment to control a network service obtained from the network as defined in the method of the first aspect or as defined in any one of the embodiments of the first aspect.

In a third aspect, the present disclosure provides a method for a user equipment (UE) to obtain a User-Centric Management and Control (UCM) service offered by a network. The method comprises, by a control, management and operation (CMO) function module instantiated in the network: receiving, from the UE, a request for the UCM service; and generating a virtual UE (VUE), the VUE having at least one NF configured to be controlled exclusively by the UE, the at least one NF configured to coordinate with the network to provide the UCM service.

In some embodiments, generating the VUE includes sending a request to an orchestrator to instantiate the VUE, and the method may further comprise: receiving, from the orchestrator, a message indicating an instantiation of the VUE.

In some embodiments, the UE is controlled by a user at the UE or a user application running at the UE, and the at least one NF is configured to receive instructions from the UE in accordance with input provided by the user at the UE or by a user application running at the UE.

In some embodiments, the UCM service is a selected UCM service; and the orchestrator is configured to access blueprints that define creation, configuration and operation procedures for a VUE type, and each VUE type is configured to provide one or more than one UCM service offered by the network, the selected UCM service may be one of the one or more than one UCM service.

In some embodiments, the method may further comprise, by the CMO function module: sending, to the UE, a notification message notifying the UE that the UCM service is available.

In some embodiments, the method may further comprise, by the CMO function module: receiving a trigger for triggering the UCM service.

In some embodiments, the UCM service may be configured to provide the UE at least one of: control over the UE traffic; control over processing of data associated with the UE; and control over the NFs in the network, the controlling over the NFs comprising Life Cycle Management (LCM) of NFs that include at least one of instantiation, modification, NF resources scaling and a termination of NFs.

In some embodiments, the VUE has functions configured to operate as at least one of: a control plane function; a user plane function; a data storage function; and a computing facilities function.

In some embodiments, the at least one NF is configured to cooperate with other NFs to do at least one of: authenticate the UE; authorize on behalf of the UE; interact with the UE to obtain a user context; control the user traffic; obtain the user traffic for internal processing; control access to VUE functions and data; interact with the UE to obtain the user data; store at least a portion of the user data; and share at least a part of the user data with the network.

In some embodiments, the CMO function module includes a VUE creation function (VUCF); and sending, to the orchestrator, the request to instantiate the VUE is performed by the VUCF.

In some embodiments, the CMO function module includes a lifecycle management (LCM) function; and receiving, from the orchestrator, the message indicating the instantiation of the VUE is performed by the LCM function.

In some embodiments, the method may further comprise: receiving, from the UE, a trigger for the UCM service; and operating the VUE to perform the NFs to provide the UCM service using available network resources.

In a fourth aspect, the present disclosure provides a network node, the network node being part of a network, the network node comprising: a processor; and a tangible, non-transitory memory having recorded thereon instructions to be carried out by the processor to carry out a method for a user equipment to obtain a User-Centric Management and Control service offered by the network as defined in the third aspect or in any of the embodiments of the third aspect.

In a fifth aspect, the present disclosure provides a method to obtain a user equipment (UE) service comprising, by a network offering UE services: receiving, from a user equipment (UE), a subscription to the UE service; instantiating, in the network, a virtual user equipment (VUE) configured to be controlled by the UE to provide the UE service, the instantiating of the VUE including: instantiating network functions (NFs) to be executed to provide the UE service; and instantiating a reference point between the VUE and UE, the reference point being a control plane reference point to convey control data between the VUE and the UE.

In some embodiments, the method may further comprise receiving, from the UE or from a network function of the NFs, a trigger for the UE service; and operating the VUE to perform the NFs to provide the UE service using network resources available at the network.

In some embodiments, operating the VUE to perform the NFs includes operating the VUE in accordance with UE input provided by a user of the UE.

In some embodiments, the control data may include at least one of: synchronization data to synchronize VUE data to UE data; authentication data; connection authorization data;
data packet format data; and protocol data unit (PDU) session initialization data.

In some embodiments, the reference point is a first reference point, and the control data is first control data, and the method may further comprise instantiating a second reference point, the second reference point being a control plane reference point between the VUE and a core network (CN), the second reference point configured to convey second control data from the VUE to the CN. The second control data may include at least one of: authentication control data; authorization control data; accounting control data; policy update control data; and lifecycle management control data associated with the NFs.

In some embodiments, the method may further comprise instantiating a third reference point, the third reference point being a control plane reference point between a VUE control plane function (CPF) and a core network (CN) user plane function (UPF). The third reference point may be configured to convey third control data between the VUE CPF and the CN UPF, the third control data including at least one of: control data for the VUE CPF to control a CN UPF for routing and processing; resource usage control data; and quality of experience control data.

In some embodiments, the method may further comprise instantiating a fourth reference point, the fourth reference point being a data plane reference point between the VUE and a data network (DN), the fourth reference point configured to convey user data directly between the VUE and the DN.

In a sixth aspect, the present disclosure provides a network node, the network node being part of a network, the network offering user equipment (UE) services, the network node comprising: a processor; and a tangible, non-transitory memory having recorded thereon instructions to be carried out by the processor to carry out a method to obtain a UE service offered by the network as defined in the fifth aspect or in one of the embodiments of the fifth aspect.

In a seventh aspect, the present disclosure provides a method for a user equipment (UE) to control a UE network service provided by a network offering a plurality of UE network services. The method comprises, by the network: providing, to the UE, a list of the plurality of UE services to control the network services; receiving, from the UE, a subscription request for the particular UE service; and in response to the subscription request, instantiating a virtual UE (VUE) having a NF configured to be controlled by the UE, the NF configured to cooperate with the network to provide the particular network service.

In some embodiments, the method may further comprise: receiving a trigger from the UE to activate the VUE; activating the VUE; and operating the VUE to control the particular network service.

In some embodiments, the method may further comprise instantiating a reference point between the VUE and UE, the reference point being a control plane reference point to convey control data between the VUE and the UE.

In some embodiments, the trigger may include an identification of the UE and an identification of a type of the network service needed.

In some embodiments, instantiating the VUE may include instantiating NFs and respective network interfaces associated with the VUE type.

In some embodiments, the NFs may be selected from a group consisting of: control plane functions, user plane functions, database management functions and a storage function.

In some embodiments, instantiating the VUE may include instantiating a virtualized infrastructure and a virtual user equipment manager (VUE-M) inside a trusted executive environment (TEE) provided by the network wherein the VUE is isolated (Privacy protected) from the network and permission to access the functions and data inside the TEE is controlled by the VUE.

In some embodiments, the plurality of network services may include: authentication of the UE, or authorization on behalf of the UE, or interaction with the UE to obtain user context, or control of user traffic, or acquisition of the user traffic for internal processing, or control of access for the user traffic, or interaction with the UE to obtain user data, or storage of at least a portion of the user data, or sharing at least a part of the user data with the network, or a combination of thereof.

In some embodiments, the network services may further include management of network components services.

In an eight aspect, the present disclosure provides a network node, the network node being part of a network, the network offering a plurality of user equipment (UE) network services, the network node comprising: a processor; and a tangible, non-transitory memory having recorded thereon instructions to be carried out by the processor to carry out a method for a UE to control a UE network service as defined in the seventh aspect or in any one of the embodiments of the seventh aspect.

In a ninth aspect, the present disclosure provides a method for a user equipment (UE) to control a network service obtained from a network. The method comprises, by a user-controlled function instantiated in the network: receiving, from the UE, an identification of a network service type; configuring the network to control the network service type; sending, to the UE, an indication that the UE has control over the network service; receiving an indication of an initiation of a session belonging to the network service; and controlling at least of data associated with the network service, and traffic belonging to the network service.

In some embodiments the user controlled function is initiated and configured by an LCM function of the network according to a user request.

In some embodiments, a user of the UE or a user function may control the UE in accordance with a control policy.

In a tenth aspect, the present disclosure provides a method for a user equipment (UE) to control a network service offered to the UE by a network. The method comprises, by the UE: sending, to a control, management and operation (CMO) function module instantiated in the network, a request to control the network service, to cause the CMO function module to instantiate at least one network function (NF) configured to be controlled by the UE and to cause the CMO function module to configure the at least one NF to control the network service in accordance with instructions received from UE; and receiving, from the CMO function module, an indication that the UE controls the UE service.

In some embodiments, the UE may obtain the offered network service and the UE may send a specific instruction to the VUE to control the offered network service to cause the offered network service to be modified according to the specific instruction.

In some embodiments, sending, to the CMO function module the request to control the network service may be to cause the CMO function module to instantiate a NF module defining a virtual UE (VUE), the VUE comprising the at least one NF.

In some embodiments, the UE may be controlled by a user at the UE or a user application running at the UE, and at least one of the at least one NF may be configured to receive instructions from the UE in accordance with input provided by the user at the UE or by the user application.

In some embodiments, the at least one NF is configured to coordinate with the CMO function module to control the network service.

In some embodiments, the network may be configured to do, in response to the request from the UE, at least one of: provide to the UE, software configured to communicate with the VUE; provide authentication keys to the UE and to the VUE to enable secure communication between the UE and the VUE; provide a procedure for the UE to control the network service, the procedure defining how to establish a communication session for the network service; provide identifiers to be used by the CMO function module to identify messages associated to a control of the network service; and provide addresses of functions with which the UE has to communicate to control the network service.

In some embodiments, the network may comprise a trusted execution environment (TEE) within which the VUE operates, wherein the VUE may be isolated from the network and permission to access the at least one network function and data inside the TEE may be controlled by the VUE according to an access policy.

In some embodiments, the VUE may have at least one VUE policy that defines how the VUE and the at least one network function operate, the at least one VUE policy may be based on one or more of: a UE policy set by a user of the UE or by a user application running at the UE; privacy schemes provided by the network; an access policy defining the permission to access the functions and data inside the VUE; and network environment information comprised of one or more of: network privacy preserving methods; information about network functions inside the CMO function module; a network topology; and a charging method to charge for network services.

In some embodiments, the CMO function module may include a VUE creation function (VUCF); and the request for the UE to control the network service may be received at the VUCF and provided by the VUCF to an orchestrator configured to generate the VUE.

In some embodiments, the CMO function module may include a life cycle management (LCM) function configured to: request the instantiation, modification and termination of the VUE from an orchestrator; and receive, from the orchestrator, a message indicating to the VUE that the request has been executed.

In some embodiments, at least one of the at least one NF is configured to coordinate with the VUE and take actions in accordance with requests made by the VUE to control the network service.

In some embodiments, the at least one NF may be configured to operate as at least one of: a control plane function; a user plane function; a data storage function; and a computing facilities function.

In some embodiments, the at least one NF in cooperation with other NFs may be configured to do at least one of: authenticate the UE; authorize on behalf of the UE; interact with the UE to obtain a user context; control the user traffic; obtain the user traffic for internal processing; control access to the at least one NF and data associated with the VUE; interact with the UE to obtain user data; store at least a portion of the user data; share at least a part of the user data with the network; and manage the at least one NF.

In some embodiments, the UE, through the VUE, may control the network service, the network service including at least one of: a UE traffic service based on a user traffic policy; a data processing service of data associated with the UE; and a life cycle management (LCM) service of the at least one NF inside the CMO function module, the LCM service including at least one of an instantiation of the at least one NF, a scaling of NF resources used by the at least one NF and a termination of the at least one NF.

In some embodiments, the network may comprise a core network having core NFs, and the VUE may be configured to control the core NFs, the core NFs including at least one of: a routing function, a data processing function and a traffic forwarding function.

In some embodiments, the network service may be a protocol data unit (PDU) session and the method may further comprise, the UE device: sending a PDU session initiation indication to at least one of the at least one NF configured to be controlled by the UE; and controlling the network service in accordance with the at least one NF configured to be controlled by the UE.

In an eleventh aspect, the present disclosure provides a user equipment (UE) device coupled to a network, the network offering a plurality of user equipment (UE) network services, the UE device comprising: a processor; and a tangible, non-transitory memory having recorded thereon instructions to be carried out by the processor to carry out a method for a the UE device to control a UE network service as defined in the ninth aspect or in the tenth aspect or in any one embodiment of the ninth aspect or the tenth aspect.

In a twelfth aspect, the present disclosure provides a tangible, non-transitory memory having recorded thereon instructions to be carried out by a processor to carry out any one of the methods defined above.

### BRIEF DESCRIPTION OF THE DRAWINGS

FIG. 1 shows a block diagram of a UE, 3GPP network elements and a data network interconnected through VUE interfaces, in accordance with embodiments of the present disclosure.

FIG. 2 shows a VUE generation/creation process flow in accordance with embodiments of the present disclosure.

FIG. 3 shows a VUE generation/creation process flow in accordance with other embodiments of the present disclosure.

FIG. 4 shows an embodiment of an operation framework with a VUE of type C in accordance with the present disclosure.

FIG. 5 shows a process flow of the messages shown in FIG. 3 in accordance with the present disclosure.

FIG. 6 shows a flow diagram of an embodiment of a method in accordance with the present disclosure.

FIG. 7 shows a block diagram of an embodiment of an electronic device, in accordance with the present disclosure.

### DETAILED DESCRIPTION OF ILLUSTRATIVE EMBODIMENTS

Embodiments of the present disclosure may provide a UE the ability to dynamically engage parts of the network or the network's elements for the UE's exclusive services. As the UE selectively engages the network elements, the UE context (e.g., the UE's location and/or mobility conditions) may be used to dynamically modify the network functionality and operation. Thus, the UE or even the UE's own network (e.g., a home network or a local area network) may become a part of the network the UE is engaging. The UE can also become a producer or a provider of services to the network. Examples of such services provided to the network by the UE may include, for example, artificial intelligence (AI) services, neighbor information, video services, and base station (BS) services provided by a UE's drone.

In the context of the present disclosure, a VUE may have one or more control plane function (CPF) interacting with the control plane functions of the core network (CN) to control UCM services provided by the network. Control of the core network may include, for example, authorizing on behalf of user, one or more of obtaining various network services, use of data by the other entities, downloading data from external services, contractual agreements or financial agreements controlling the routing of traffic through a user plane, changing traffic forwarding policies dynamically, and obtaining specific technical features to facilitate the network services dynamically. Control of the network may further include management of the network elements in the network. These network elements may be network functions in the network or any hardware structure belong to the network. The management may include instantiation of the network functions and allocating resources to those network functions. In some embodiments, the network services may include management of network components services.

In the context of the present disclosure the term ‘UE’ may represent a combination of a network access device (NAD) and a user personal device (UPD). It may also refer to the person who uses the UE. Also, in the context of the present disclosure, a VUE is a digital entity located in the network and represents both the NAD and the UPD or the person who owns and uses the UE. UCM services may be provided by deploying the VUE by at least one network node of the network. The user applications and user data can be considered as higher layer components of the UE. These higher layer components may be considered to be the UPD. The UE can use its applications in the NAD to facilitate UCM services. A VUE may have different functionalities depending on the UCM service types it provides. In the context of the present disclosure, the term VUE type is a VUE having functionalities that can provide specific types of UCM services. The VUE may be deployed at different segments of the network (e.g., RAN, CN, mobile edge computing node (MEC), etc.) in a hierarchical manner to support various UCM services for UEs. The VUE may represent a particular UE and facilitate certain actions on behalf of the UE to support applications and services engaged throughout the network. There may be different types of VUEs providing different types of UCM services. Not all UEs may require user empowerment and therefore, a VUE or a UCM service may be provided as an add-on feature to the UE. A UE, requiring a particular UCM service, may have to subscribe to a particular VUE type or a UCM service (a VUE type may be configured to provide multiple UCM services). Subscription may be done by the UE contacting the mobile network operator's (MNO's) service desk or through an application provided in the UE, in which case the UE may send a special request to the network. The network may request a VUE creation function (VUCF) in the network to instantiate the VUE. Instantiation of the VUE may include the instantiation of at least one NF belonging to the VUE and its required interfaces. In one embodiment, the instantiation of the VUE may include the instantiation of a VUE-M (VUE manager) which has the capability of instantiating other NFs and interfaces belong to the VUE. There may be multiple VUEs located in different parts of the network (e.g., in different parts of a 3GPP network) and in data networks (DNs). In some embodiments the VUE creation request may be made by another, already existing, VUE. In some embodiments, instantiating the VUE may include instantiating NFs and respective interfaces associated with a VUE type.

When a VUE is created (generated) it may be created with a VUE-Manager (VUE-M), other network functions (i.e., UPFs and CPFs) and a database. Creation of the VUE may include engagement of a virtualized infrastructure and a VUE-M. The VUE-M may use the virtualized infrastructure to instantiate the other network functions and the interfaces, necessary for the requested VUE type. Similar wording as para 112 to cover Claim 39. The infrastructure may be part of the hosting network, or it may be a hardware platform provided by a third party vendor, as a trusted executive environment. In some embodiments, instantiating the VUE may include instantiating NFs and respective interfaces associated with a VUE type.

The VUE instantiation may include instantiation of functions together with interfaces required for the requested UCM features in the network, which may be a wireless network. With the required interfaces in place, the VUE may interact with the network on behalf of the UE to engage the requested UCM features without direct interaction between the UE and the functions in the access network, for example, over an air interface when the UE is a wireless device.

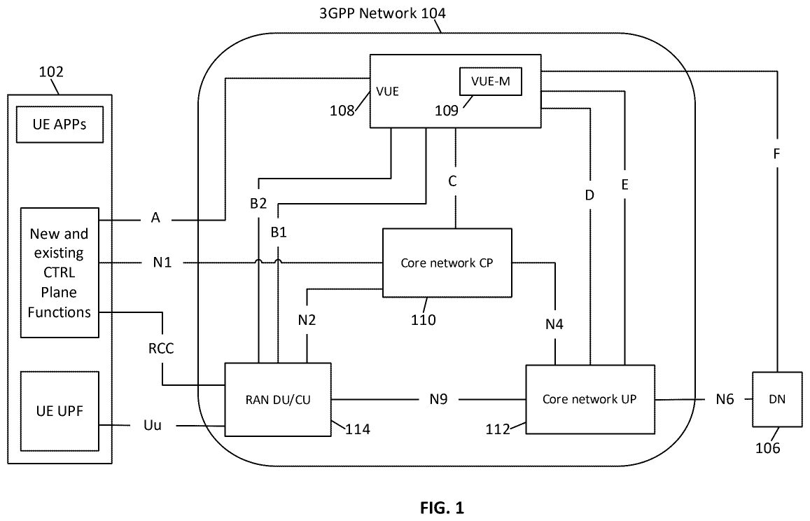

FIG. 1 shows a block diagram of a UE 102, a 3^{rd} Generation Partnership Project (3GPP) network 104 elements and a data network (DN) 106 interconnected to each other through VUE interfaces (also referred to as reference points), in accordance with embodiments of the present disclosure. The 3GPP network 104 may include a VUE 108, a VUE-M 109, a core network (CN) control plane (CP) 110, a core network user plane (UP) 112 and a RAN distributed unit (DU)/central unit (CU) 114. In the embodiment of FIG. 1, VUE operations may require several control plane and data plane interfaces between the UE 102 and elements of the 3GPP network 104, and between elements of the 3GPP network 104 and the DN 106. The required interfaces may depend on the type of UCM services, facilitated by the VUE. A given interface may be used only by some UCM services. In addition to the interfaces that are defined in 5G standards, additional interfaces or additional messaging over the existing interfaces may be required for VUE deployment and operation. Several interfaces may be required for operation of the VUE 108. In the context of the present disclosure, an interface may be referred to as a reference point and vis-versa.

VUE-UE control plane reference point (A)—Interface A is shown in FIG. 1 and is mainly for UE to VUE control plane messaging, transparent to the network. The interface A may be configured to synchronize, between the UE 102 and the VUE 108, the UE data (e.g., UE context, location), to provide authentication, authorization, and information in relation to the connections between the VUE and UE, data packet formats and any new UCM protocol data unit (PDU) session initialization. Depending on the UCM service, synchronization of a high volume data flow may require a logical data plane connection between the UE 102 and the VUE 108. The data plane connection may be established by the network, for example, via a Uu interface and a B2 interface, in response to a request from the VUE 108 or the UE 102. For this purpose, the UE 102 may send control plane messages to the VUE 108 through the VUE-UE control plane reference point A interface. NFs in the network (or at least one NF in the network) may be configured to interact with the UE to obtain a user context.

VUE-RAN control plane interface (B1)—Interface B1 is for certain UCM services such as, for example, when the VUE 108 requires specific radio access network (RAN) technologies or features. The VUE 108 may use this reference point to make such requests. In addition, this logical link (interface B1) may be used for direct UE functionality authentication, which is similar to an access and mobility-management function (AMF) functionality.

VUE-RAN data plane interfaces (B2)—For some UCM applications, interface B2 may be used to direct UE traffic to and from the VUE 108, transparent to the hosting network (Core Network or RAN). The N9 and N4 reference points may be used for the same purpose.

VUE-CN control plane reference point I—The CN CP 110 may have a single entry reference point (interface C) to a VUE control plane engaged to set up connections, authentication, authorization and accounting (AAA), policy update handling and lifecycle management of network functions at the VUE 108.

VUE CPF-CN UPF reference point (D) interface—Interface D is used by certain types of UCM services that enable VUE CPFs to control CN UPFs for routing and data processing purposes if the network operator allows certain level of control on certain UPFs. The D reference point interface may also be used for monitoring UE traffic related information (e.g., resource usage, quality of experience (QoE), different flows routing to different processing functions, UPFs or DNs). NFs in the network (or at least one NF in the network) may be configured to obtain the user traffic/data for internal processing.

VUE-CN data plane reference point I interface—Interface E is for UCM services when there is a requirement for certain data processing at the VUE 108 or when certain data has to be terminated or started at the VUE 108. In this case user traffic originated by the UE 102 or the DN 106 is diverted to the VUE 108 using this interface. NFs in the network (or at least one NF in the network) may be configured to obtain the user traffic/data for internal processing.

VUE-DN data plane reference point (F) interface—Interface F is to send and receive data directly between the VUE 108 and DN 106. The interface is required only for certain UCM services.

There are numerous options for defining reference points for interactions between different VUE control plane functions (CPFs) and different CN CPFs. For example, a standard may define a number of reference points for the interactions between a specific VUE CPF to a specific CN CPF. It is also possible that a single reference point may be defined for all control plane communications between the VUE 108 and each network domain (e.g., VUE or CN).

In addition to already described reference points, a number of 5G network reference points (e.g., in 23.501, 3GPP), for example, N1 and N2, may have to be modified to include UCM functionality and support required messaging for the VUE 108 and for UCM services.

N1 reference point between the UE 102 and an access and mobility management function (AMF). In addition to the relevant functions defined in the 3GPP TS 23.501 standard for this reference point, to support a VUE or a UCM service, the N1 reference point may be used to convey the VUE policy and parameters (including VUE service authorization) from the CN (e.g., AMF) to the UE 102, and convey the VUE 108 and UCM interaction capabilities to the CN CPF (e.g., AMF). Furthermore, establishment of a sync channel and an initial authentication procedure between the VUE 108 and the UE 102 may be done via the N1 reference point. The sync channel establishment and authentication may be done by the AMF following a request from a session mobility function (SMF).

N2 reference point defines a link between a RAN and the CN (e.g., the AMF). In addition to the relevant functions defined in 3GPP TS 23.501, the N2 reference point, configured to support VUE and UCM services, may convey VUE policies and parameters (including a VUE service authorization) from the AMF to the RAN (or a next-generation radio access network (NG-RAN)).

Uu reference point between the UE 102 and the RAN, is configured to support UCM functionality and may provide additional quality of service (QoS) bearers for specific UCM services and sync channels.

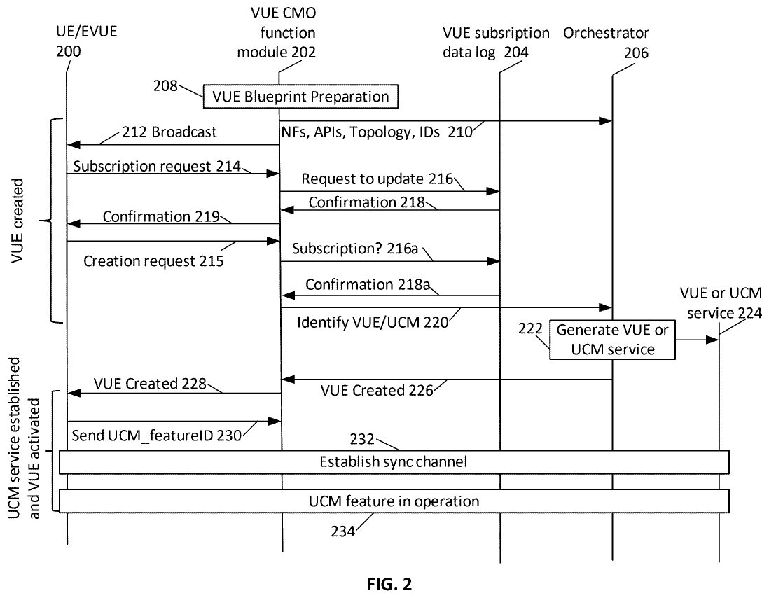

FIG. 2 shows an embodiment of a process flow for the generation/creation of a VUE and of an associated UCM service for the VUE, in accordance with the present disclosure. The process flow of FIG. 2 takes place in a communication network that may include a UE, an existing VUE or both a UE and an existing VUE. The UE and/or an existing VUE (EVUE) of the UE are shown at 200. The UE and/or EVUE 200 may be controlled by a user of the UE or by an application running on the UE and/or EVUE 200. The communication network includes a VUE control, management, and operation (CMO) function module 202 that may be instantiated at a node of the network. The VUE CMO function module 202 may include a set of functions needed to support the creation, life cycle management and operation of a VUE. Certain functions represented by the VUE CMO function module 202 may be management plane functions such as, for example, OAM functions (e.g., a VUE service management (VSM) function). Other functions represented by the VUE CMO function module 202 may include control plane functions (e.g., a VUCF). In some embodiments, a user of the UE or a user function may control the UE in accordance with a control policy.

The VUE CMO function module 202 may be configured to prepare a blueprint for different VUE types and for each of the UCM features to be provided by the network. The VUE CMO function module 202 is coupled to a VUE subscription data log 204, which may be configured to include a list of UEs and of the types of UCM services or VUE types the UEs of the network are already subscribed to or may subscribe to. As EVUEs (existing VUEs already instantiated in different locations of the network) may also subscribe to additional VUEs or additional UCM services, the VUE subscription data log 204 may also include or be updated to include a list of the EVUEs and of the respective other VUEs to which they may subscribe. The VUE CMO function module 202 is also coupled to an orchestrator 206, which may be configured to create VUE functions, which may include network functions (NFs), application programming interfaces (APIs) and topology requirements for selected VUE types that have identifiers to be used by the CMO function module to identify messages associated to controlling a network service (the selected VUE types may be identified by the identifier VUE_TypeIDs) and UCM features (identified by the identifier UCM_ServiceTypeIDs).

At action 208, the VUE CMO function module 202, which is configured to contain a list of VUEs and UCM services provided by the network and all the information required to prepare blueprints of different types of VUEs and/or UCM service types, prepares one or more than one VUE blueprint. In the context of the present description, a VUE blueprint is a set of instructions and/or data that defines a VUE and its instantiation and operation The VUE blueprint may include NFs, APIs, network topology requirements such as specific processing functions, configuration requirements and IDs corresponding to the VUE types and UCM service types listed at the VUE CMO function module 202. At action 210, the VUE CMO function module 202 may identify and/or provide, to the orchestrator 206, the one or more than one VUE blueprint of different VUE types and UCM services. The VUE CMO function module 202, or the node at which the VUE CMO function module 202 is deployed, may broadcast, at action 212, to the UEs/EVUEs 200 coupled to the network, the VUEs, UCM service types and the identification of the UCM services offered by the VUE CMO function module 202. At action 214, a UE/EVUE VUE 200 may identify itself to the VUE CMO function module 202 and select or request a specific VUE or UCM service type identified in the broadcast message received from the VUE CMO function module 202. The request may include at least one of a UE_ID, a VUE_TypeID, and a UCM_ServiceTypeID of the requested VUE or UCM service. NFs in the network (or at least one NF in the network) may be configured to obtain the user traffic/data for internal processing.

Obtaining a VUE may require multiple steps (actions) such as, for example, the subscription request step 214 and the creation request step 215. In the subscription request step 214, a UE/EVUE 200 may subscribe to a UCM service type or to a VUE type by sending a subscription request to the VUE CMO entity 202. In an embodiment, a user application deployed at a UE may make this subscription request to a VUE service management function (VSM) which is part of the VUE CMO function module 202. In another embodiment the UE/EVUE 200 may make this subscription request to a management plane function, which is part of the VUE CMO function module 202. After receiving the subscription request 214, the management plane function may request, at action 216, a control plane function to update the VUE subscription data log 204 with the particular type of VUE or the UCM service requested by the UE/EVUE 200. After having been successfully updated with the particular type of VUE or the UCM service requested by the UE/EVUE 200, the VUE subscription data log 204 may send, at action 218, a message to the VUE CMO function module 202 to confirm, to the VUE CMO function module 202, the update of the VUE subscription log 204. In turn, the VUE CMO function module 202 may send to the UE/EVUE 200, at action 219, a confirmation message to notify the UE/EVUE 200 of the successful update of the VUE subscription log 204. Having received the confirmation message to indicate the successful subscription, the UE/EVUE 200 may now send a VUE creation message (e.g., see action 215) whenever the UE/EVUE requires to create a VUE or requires to obtain a UCM service. After the subscription request 214 is sent to the VUE CMO 202, and after actions 216 and 218, the same UE/EVUE 200 may send, at action 215, to a VUE control plane function included in the VUE CMO function module 202, a request to create the VUE. The creation of the VUE may include an instantiation of the VUE. The instantiation of the VUE may comprise the instantiation of at least one NF belonging to the VUE and its required interfaces. In one embodiment, the instantiation of the VUE may include the instantiation of a VUE-M (VUE manager) which has the capability of instantiating other NFs and interfaces belong to the VUE. In some embodiments, instantiating the VUE may include instantiating NFs and respective interfaces associated with a VUE type.

In some embodiments, when the subscription request 214 is received at the VUE CMO function module 202, the hosting network creates the VUE and accordingly generates a VUE creation request after updating the subscription. That is, in some embodiments, the VUE CMO function module 202 may be configured to proceed with the generation (creation) of the VUE without having to receive a creation request, from the UE/EVUE, distinct from the subscription request 214.

In some embodiments, the UE/EVUE 200 first subscribes to a VUE before requesting the VUE creation. In that case, after subscription, the UE/EVUE 200 requests, at action 215, the creation of a UCM service or a VUE type. The request is made to the VUCF function comprised in the VUE CMO function module 202. Following action 215, the VUCF function in the VUE CMO entity 202 may request, at action 216a, that the VUE subscription data log 204 confirm that the UE/EVUE 200 has a subscription to the VUE or UCM service identified to the VUE CMO function module 202 at action 214. Upon successfully verifying the subscription, the VUE subscription data log 204 may send, at action 218a, a message to the VUE CMO function module 202 to confirm the subscription. After receiving the confirmation. Subsequently, the VUCF in the VUE CMO function module 202 may send, at action 220, a message to the orchestrator 206 to identify the VUE or UCM service selected by the UE/EVUE 200 at action 214. The orchestrator 206 may then identify and use the required NFs, APIs, Topologies, VUE and UE IDs to generate (instantiate), at action 222, the VUE or UCM service 224. Instantiating the VUE or the UCM service may include instantiating at least one NF configured to be controlled by the UE. The at least one NF may be said to define a NF module, which defines the VUE or UCM service. One or more of the at least one NF is configured to receive instructions from the UE in accordance with input provided by the user at the UE or by a user application running at the UE. The instruction indicates how the network service is controlled by the at least one NF. At action 226, the orchestrator 206 sends a message to the VUE CMO function module 202 to indicate that the VUE or UCM service has been created (generated, instantiated). In turn, the VUE CMO function module 202 sends, at action 228, a message to the UE/EVUE 200 to indicate that the VUE or UCM service has been created (generated, instantiated, is available) and/or that the UE controls the network service. This action 228 also include instructions on how the procedure of how the use controls the network service when initiating, operation, modification or terminating a PDU session belong to the network service. In one embodiment the packet formats of the communication packets sent by the user are provided. This includes the change of the header of the packet indicating one or more of the network service type, destination, the type of processing required, privacy required, routing information, QoS information, what VUE or the network should do with the packet.

At action 230, the UE/EVUE 200 may identify the desired UCM service types to be added to the VUCF function in the VUE CMO function module 202 by providing the related UCM_ServiceTypeID to the VUE CMO function module 202. Each UCM service may have a UCM service type, which may be identified by a UCM_ServiceTypeID. Subsequently, the VUE CMO function module 202 creates (generates) the necessary functions inside the VUE to provide the UCM service using the orchestrator and establishes a sync channel 232 between the UE/EVUE 200 and the VUE or UCM service 224. The UCM service may then be in operation at 234. In some embodiments, the at least one NF (e.g., in a VUE or UCM service) may be configured to coordinate with the CMO function module 202 to control the UCM service or a network service.

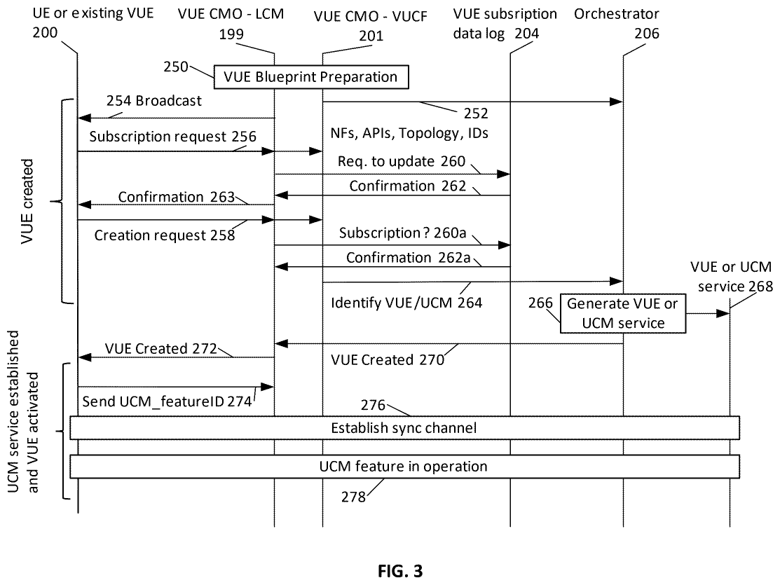

FIG. 3 shows an embodiment of a VUE service generation/creation process flow in accordance with embodiments of the present disclosure. In contrast to FIG. 2, FIG. 3 shows a VUE CMO-LCM function 199 and a VUE CMO-VUCF 201, both of which comprised in the VUE CMO entity 202 shown in FIG. 2.

FIG. 3 shows a process flow for the generation/creation of a VUE and of an associated UCM service for the VUE, in accordance with embodiments of the present disclosure. Similar to the process flow embodiment shown in FIG. 2, the process flow of FIG. 3 takes place in a communication network that may include a UE, an existing VUE or both a UE and an existing VUE. The UE and/or an existing VUE (EVUE) of the UE are shown at 200. The communication network includes VUE CMO functions such as a VUE CMO LCM function 199 and a VUE CMO VUCF 201 that may be instantiated at a node of the network. VUE CMO LCM function may be instantiated and configured by the VUE CMO function.

The VUE CMO LCM function 199 and the VUE CMO VUCF 201 may be configured to prepare one or more than one VUE blueprint. The VUE CMO LCM function 199 is coupled to a VUE subscription data log 204, which is configured to include a list of UEs and of the types of UCM services or VUE types the UEs of the network are already subscribed to or may subscribe to. As EVUEs (existing VUEs already instantiated in different locations of the network) may also subscribe to additional VUEs or additional UCM services, the VUE subscription data log 204 may also include or be updated to include a list of the EVUEs and of the respective other VUEs to which they may subscribe. The VUE CMO VUCF 201 is coupled to an orchestrator 206, which may be configured to create VUE functions, which may include NFs, APIs and topology requirements for selected VUE types (identified by the identifier VUE_TypeIDs) and UCM features (identified by the identifier UCM_ServiceTypeIDs).

At action 250, the VUE CMO LCM function 199 and the VUE CMO VUCF 201, which are configured to contain a list of VUEs and UCM services provided by the network and all the information required to prepare blueprints of different types of VUEs and/or UCM service types, prepare one or more than one VUE blueprint. The VUE blueprint may include NFs, APIs, network topology requirements such as specific processing functions, configuration requirements and IDs corresponding to the VUE types and UCM service types listed at the VUE CMO LCM function 199 and at the VUE CMO VUCF 201. At action 252, the VUE CMO VUCF 201 may identify and/or provide, to the orchestrator 206, the one or more than one VUE blueprint of different VUE types and UCM services. The VUE CMO LCM function 199, or the node at which the VUE CMO LCM function 199 is deployed, may broadcast, at action 254, to the UEs/EVUEs 200 coupled to the network, the VUEs, UCM service types and the identification of the UCM services offered by the VUE CMO LCM function 199. At action 256 a UE/EVUE 200 may identify itself to the VUE CMO LCM function 199 and to the VUE CMO VUCF 201 and select or request a specific VUE or UCM service type identified in the broadcast message. The request may include at least one of a UE_ID, a VUE_TypeID, and a UCM_ServiceTypeID of the requested VUE or UCM service.

Obtaining a VUE may require multiple steps (actions) such as, for example the subscription request 256 and the creation request 258. Once subscribed for a UCM service a UE is eligible to request a creation of a VUE whenever UE needs such service. In the subscription request 256, a UE/EVUE 200 may subscribe to a UCM service type or to a VUE type by sending, at action 256, the subscription request to the VUE CMO LCM function 199 and to the VUE CMO VUCF 201. In some embodiments, the VUE CMO LCM function 199 may request, at action 260, a control plane function to update the VUE subscription data log 204 with the particular type of VUE or the UCM service requested by the UE/EVUE 200. Subsequently, at action 262, the VUE subscription data log 204 may provide confirmation of the update to the VUE CMO LCM function 199. In turn, the VUE CMO LCM 202 may send to the UE/EVUE 200, at action 263, a confirmation message to notify the UE/EVUE 200 of the successful update of the VUE subscription log 204. That is, the confirmation indicates that the UE/EVUE 200 is now registered for a VUE service and that is able to request that the VUE service be created (e.g., see action 258).

In some embodiments, after the confirmation 262 of the update to the VUE subscription data log 204, the UE/EVUE 200 may send, at action 258, to the VUE CMO LCM function 199 and to the VUE CMO VUCF 201, a request to create the VUE. Thus, the UE/EVUE 200 first subscribes to a VUE before requesting the VUE creation. In some embodiments, the UE/EVUE 200 may request, at action 258, the creation of a UCM service or a VUE type. The request is made to the VUE CMO LCM function 199 and to the VUE CMO VUCF 201. Following action 258, the VUE CMO LCM function 199 may request, at action 260a, that the VUE subscription data log 204 confirm that the UE/EVUE 200 has a subscription to the VUE or UCM service identified to the VUE CMO LCM function 199 and to the VUE CMO VUCF 201. Upon successfully verifying the subscription, the VUE subscription data log 204 may send, at action 262a, a message to the VUE CMO LCM function 199 to confirm the subscription. After the UE/EVUE 200 sends, at 258, the VUE creation request to the VUE CMO LCM 199 and to the VUE CMO VUCF 201, the VUE CMO VUCF 201 may send, at action 264, a message to the orchestrator 206 to identify the VUE or UCM service selected by the UE/EVUE 200. The orchestrator 206 may then identify and use the required NFs, APIs, Topologies, VUE and UCM service type to generate (instantiate), at action 266, the VUE or UCM service 268. At action 270, the orchestrator 206 sends a message to the VUE CMO LCM function 199 to indicate that the VUE or UCM service has been created (generated, instantiated). In turn, the VUE CMO LCM function 199 sends, at action 272, a message to the UE/EVUE 200 to indicate that the VUE or UCM service has been created (generated, instantiated).

At action 274, the UE/EVUE 200 may identify, to the VUE CMO LCM function 199, the desired UCM service type to be added by providing the related UCM_ServiceTypeID to the VUE CMO LCM function 199. Subsequently, the VUE CMO LCM function 199 takes action to create (generate) the necessary functions inside the VUE to provide the UCM service using the orchestrator 206 and establishes a sync channel 276 between the UE/EVUE 200 and the VUE or a UCM service function 224. The UCM service may then be in operation at 278.

In some embodiments, after the UE/EVUE has subscribed to a VUE, a VUE instantiation may be prepared. Preparation steps may include a VUE descriptor or a blueprint generation and an identification of resources required without actually instantiating the functions required for the VUE. There may be different blueprints for different types of VUEs. The blueprint may further include the VUE functions and interfaces, associated parameters and specific software required for operation of the particular type of VUE. For example, software for the UE to communicate with the VUE, or a procedure that defines how to establish a communication session for a network service. In some embodiments, preparation of blueprints for different VUE types and UCM services may be done by the network anticipating a VUE subscription requests from the UEs. Because the resource requirements have already been identified, when the UE/EVUE requests a VUE instantiation for the first time, or when the UE is connected to the network for the first time, the corresponding VUE may be created with minimum delay. In some cases, the UE may request the VUE creation to a specific function in the hosting network, which may be a VUE creation function (VUCF).

A VUE blueprint preparation function for a particular VUE type, performed by the hosting network, identifies the required network functions inside the particular VUE type, the required interfaces, associated operation policies, and configuration parameters for each type of UCM service to be facilitated by the particular VUE type. The VUE blueprint preparation function also identifies interfaces with the VUE input and output ports for each network function (NF) of the VUE. All these resources and structural elements required to operate a particular VUE type are identified prior to creation of a VUE and the identification of the resources and structural elements may be stored in the hosting network's database. When a UCM service is requested, the VUE blueprint preparation function may provide the stored information to a VUE manager (VUE-M) to establish required functions and interfaces. The VUE-M may be part of the VUE or UCM service 224.

The hosting network requires a function such as a VUCF to receive VUE/UCM service requests and initiate a VUE or a UCM service creation process. The hosting network may also require a function subscription log to manage UE subscriptions to the UCM services or VUE types. Prior to service creation a VUE creation request may be authorized by checking UE's subscription profile. Creation of the VUE includes creation of a private VUE platform and a corresponding VUE-M. This may be created as a software instantiation inside a trusted executive environment (TEE) installed in the network. This may allow the VUE to be isolated from the network and permission to access the at least one network function and data inside the TEE is controlled by the VUE according to an access policy. The access policy may define the permission to access the functions and data inside the VUE. It may also be created by using a network functions virtualization infrastructure (NFVI) coordinating the process. In the case of a UCM trigger, after authenticating the UE, the VUCF may ask the VUE-M to establish the required functions. In some cases, the UE may directly request the VUE-M to establish the UCM service dynamically, and the VUE-M may follow by creating the required functions and interfaces. In some embodiments, the VUE is Instantiated using the hosting network's infrastructure using a MNO's NFVI. In some embodiments, the VUE is instantiated by the VUE platform manager using infrastructure provided for the platform. The hosting network may also require a policy function to provide policies regulating traffic flows to the VUE. The hosting network may also require a function to provide VUE policies and communication parameters such as those for UCM service operation (e.g., required header fields in the packet formats for different UCM services) to the UE. In some embodiments, the network may be configured to do provide to the UE, software configured to do at least one of the following actions; communicate with the VUE; to provide authentication keys to the UE and to the VUE to enable secure communication between the UE and the VUE; to provide a procedure for the UE to control the network service, the procedure defining how to establish a communication session for the network service; provide identifiers to be used by the CMO function module to identify messages associated to a control of the network service; and provide addresses of functions with which the UE has to communicate to control the network service. Furthermore, the VUE may have at least one VUE policy that defines how the VUE and the at least one network function operate. The at least one VUE policy may be based on one or more of: a UE policy set by a user of the UE or by a user application running at the UE; privacy schemes provided by the network; an access policy defining the permission to access the functions and data inside the VUE; and network environment information. The network environment information may comprise one or more of: network privacy-preserving methods; information about network functions inside the CMO function module; a network topology; and a charging method to charge for network services. Additionally, the hosting network may require a function to fetch the UE capabilities, related to the UCM services and to the VUE types and assess whether the UE is capable to support certain UCM services. This may also be done by the VUCF function. The hosting network may also require a function to provide the UE with software for the VUE operation and UCM services prior to establishment of the UCM services. This may include assessment of how UCM service traffic maps to lower layer protocols.

As shown in FIG. 2, the orchestrator 206, in response to the VUE/UCM request from the VUCF in the VUE CMO function, may create a VUE, and send an acknowledgement message back to the VUE CMO function. The acknowledgement message may be ultimately conveyed to the UE (or to another VUE or to a network function who initiated the VUE/UCM request). Following a VUE creation phase, a UCN service establishment and VUE activation phase may be engaged by the UE/EVUE. The UE/EVUE may send to the network (or to another device in communication with the network) a UCM feature request with a UCM_ServiceTypeID. Responsive to the UCM feature request, a synchronization channel may be established between the UE and the respective VUE with the VUE operating in active mode.

When the VUE is created, a separate authentication key may be established between the VUE and the UPD functions of the UE/EVUE. This may be done by initially transferring or providing the authentication keys from the CN CPF function (e.g., the AMF in 5G) to the VUE-M and UE and creating a function in the VUE for synchronization with the corresponding UE (SyncF). SyncF and UE will use the authentication keys to initially authenticate each other and afterwards they would establish a separate mutual authentication key for their communications so that those communications are not exposed to the hosting network.

The VUE may include control plane functions, user plane functions, data storage function, computing facilities functions, and required internal and external interfaces for these resources. Various functionalities may be required for the VUE, the UE and the hosting network. For example, the VUE-M manages coordination and Life Cycle Management (LCM) of the other VUE functions (CPFs, UPFs, PPP and storage). However, in some embodiments (e.g., in trusted hosting networks), the VUE-M may not be involved in functions coordination.

A privacy preserving portal (PPP) and access control function (ACF) manages privacy and access issues between the hosting network and the VUE. It is deployed inside the hosting network. One of the PPP objectives is to prevent the UE data exposure to a non-trusted host. The PPP may operate as a data filter for the UE. However, this may limit UCM services facilitated by the VUE. In addition, the hosting network access to the VUE via the control plane may need to be controlled by the access control function inside the VUE. The PPP prevents unauthorized information flow to the VUE and UE. For some UCM services the hosting network may expose the network information to the VUE. In this case, a PPP instantiated in the hosting network control plane, may control access to the hosting network information or a specific network exposure function may control network data that could be exposed.

A function (e.g., at least one NF) for the VUE to authenticate the associated UE and for the UE to authenticate the associated VUE for further communications may be created by the VUE-M or, in some cases, by the hosting network. Creation of a such authentication function may be facilitated by a CN CPF (e.g., a VUCF) firstly by establishing a connection (e.g., a sync channel) between the UE authentication function and the VUE-M. And secondly, the CN function may establish authentication keys as the CN function controls UE identification methods (e.g., secure keys associated to the UE ID). The VUE may also have a function to control access to its NFs. Additionally, the VUE may have a function to control access to the UE's data stored inside the VUE. These two functions are configured by the VUE-M or in some cases by the CMO module.

Common control plane function for external interfaces. The VUE may have a single control plane connection with the CN. In this case, the VUE may require a common control plane function, capable of identifying a request and directing the request to the appropriate CPF inside the VUE. In some embodiments, the VUE may have a control plane function to directly control certain UPFs in the hosting network, for example, for routing control or specific data processing. This function may also obtain monitored data by the CN UPFs. The core network UPFs may be exclusively provided for the VUE.

Data processing functions inside the VUE. Some VUE types may have one or more UPFs inside the VUE for the UE data processing or data redirection (or data sending) to the UE or DNs. These VUE types may have a connection to specific hosting network UPFs which can include the RAN UPFs or the CN UPFs. For this purpose, the hosting network may have certain UPFs capable of identifying these types of traffic and forwarding the traffic to the VUE UPFs. The UE may also require a function to add specific identification fields (e.g., an IP address or processing type indication) in the header to help the hosting network identify such traffic, which is performed in coordination with the hosting network CPFs. NFs in the network (or at least one NF in the network) may be configured to obtain the user traffic/data for internal processing.

VUE technology requirement assessment functions. For certain types of VUEs, the VUE may require a function to obtain resolvable technologies, features or resources available with the hosting network (e.g., RAN technologies such as diversity channels or low power channels, or specific processing functions at the RAN or CN). A technology requirement assessment function of the VUE dynamically assesses technologies, features or resources exposed by the hosing network's exposure function. This function dynamically assesses the UE requirements (based on the UE's context and the applications it uses) of the technologies, features or resources needed. The hosting network may need a function to obtain dynamic resource assignment and different QoS requirements for specific traffic flows from the VUE and establish related requirements at the CN or RAN. This may include providing additional QoS bearers to access the network and core network.

There are different types of VUEs and a UE requesting a UCM feature subscribes to an associated VUE type or to an associated UCM service. Not all UEs require user empowerment and therefore, if requested, a VUE may be provided to a UE as an add-on feature. When a UE requires a VUE, the UE may make a special request to the network. In the future, software may be developed to automatically find the UCM features matching to the UE applications. The special request is forwarded to the VUE creation function in the network. The types of VUEs or types of UCM services may be standardized for the UE to request the service. A mobile network operator (MNO) may provide the VUE facilities (e.g., the available VUE or UCM service types) based on its assessment of the required functions and associated privacy preserving methods, costs and network modifications required.

A basic or a default VUE type (VUE Type A) may be capable of creating and activating UCM services. This is the simplest type of the VUE. In some embodiments the MNO may establish the basic VUE which can be later extended by a UE request to any VUE type that can provide associated UCM services. Creation of a basic (a default) VUE enables the network or the UE to create UCM services on demand. For this purpose, the basic VUE may have a logical control link established between the UE and the VUE. The VUE may have one or more functions (e.g., a VUE-M and an orchestrator) to create additional functions required for the UCM service when these additional functions are requested by the UE or a network function. The one or more functions may include functions to trigger the creation of a UCM service when a UCM service is requested by the UE or a network function (e.g., by a VUCF), coordination functions to coordinate with the UE and network CPFs or equivalent management functions.

Particular embodiments of the basic VUE (Type AA) may contain certain descriptions of the UE which may be accessed externally using an API. These descriptions may include the UE location, a travelling direction, a remaining device power, the UE capabilities (e.g., number of antennas, full duplex capability, etc.), a received signal strength from different access points of the network, the state of the network connection (e.g., connected, active, standby, etc.), and neighbor devices information if available.

VUEs associated only with the CPFs and the storage that operate without network exposure (VUE Type B)—This type of VUE has only control plane functions and no user plane functions. This type of VUE may require a storage to keep information related to the UE, such as, user context information. The one or more control plane functions may include a function to communicate with the UE, for example to obtain user requirements. It may also include a function to communicate with the control plane functions of the hosting network. Additionally, it may have a function to control the UPFs which depends on the type of the UCM service the VUE is intended to provide. This type of VUE provides UCM services wherein, for example, the VUE takes decisions for home equipment, personal health, and trigger alarms to a personal UE (PUE), external home control systems or external health control systems. Such VUEs may analyze PUE data (e.g., in case of a network designed to support AI services of the UE (e.g., Net4AI)), share the PUE data with external entities preserving privacy, authenticating, and authorizing the PUE data (including associated payments) on behalf of the UE with third party entities the PUE data (including associated payments).

VUEs having CPFs, storage connectivity and access to exposed network information such as network state, features and facilities (VUE Type C)—This VUE type, in addition to having CPFs, is provided with capabilities to obtain certain kinds of network information, such as specific facilities available to the UEs, specific processing or traffic routing control, priority control and applicable technical features of the MNO (RAN or CN), topology or traffic monitoring for loading situations and costs. This VUE type may dynamically request special network features for the UE's dynamic requirements (e.g., low power channels), define special services and flows for efficient communications, including specific QoS for multipath diversity combining for up and down links (UL/DL), QoS rate for a UE moving path, provide a specific service consisting of a combination of flows with specific QoS requirements. This type of VUE may also provide control of its own traffic routing inside the MNO, by obtaining geographical areas with superior service quality (mapping). Elsewhere in the present disclosure, operation of certain UCM services using this type of VUE is provided as an example.

A VUE type with UPFs for traffic handling which allows the UE to process its traffic according to its own processing functions (VUE Type D)—This type of VUE allows the UE to do data processing agnostic to the network or carry out network agnostic communications with the DNs. Some examples of UCM services provided by this VUE type are: acting as as a middle person to block ads (also reduce the air interface bandwidth), local data caching and pre-fetching, privacy preservation for sending queries with different UE IDs, sharing contents interest for pre-fetching, VUE data receiving (e.g., voice recording) when the UE is offline, processing specific types of traffic (transparent to the network), changing source address for privacy, and acting as a proxy to facilitate applications and Transport Control Protocol (TCP) acceleration to avoid delay in TCP based communications. Also, this type of VUE may be capable of providing user dependent QoS requirements for a given application by adjusting the user QoS and monitoring the service quality experienced by the UE. NFs in the network (or at least one NF in the network) may be configured to obtain the user traffic/data for internal processing.

VUEs having their own resources obtained from the MNO and controlled or managed by the VUE (VUE Type E)—Resources such as certain network segments (RAN or CN parts), transport bearers, AP resource blocks, APPs, reflective intelligent surfaces (RISs), etc. can be obtained exclusively for a UE and applied to the UE's traffic.

A VUE type capable of joint network optimization by communicating with the MNO (VUE Type F)—With this type of VUE the UE may support the network services and vice versa by helping joint optimizations or supporting network services. For example, by interacting with AI for joint design, providing predicted UE information (e.g., mobility prediction for resources and tracking area, per UE based UE idling time, UE switch off or turned volume down), a VUE may ask the UE to facilitate network traffic to UE neighbours or vice versa (known neighbours from the network), or a VUE support network may deliver non-connectivity services (e.g., AI services, video or weather sensing data).

Two examples of UCM services that may be provided by the VUE, Type C: In a first example (example A) the VUE dynamically selects a RAN network specific transmission method (e.g., an antenna configuration such as MIMO or Full duplex or a power saving channel) for a particular time or for a particular communication. In a second example (example B) the VUE dynamically provides for traffic filtering by directing the UE traffic through specific UPFs, or gateways (GWs), or access points (Aps) of the network for quality improvement in case of congestion, or for cost reduction, or for a specific data processing.

Before a VUE operation starts, the VUE may be instantiated following a request from another VUE or the UE. The required functions, interfaces, and associated configurations for this type of VUE (a blueprint of the VUE, Type C) may be provided to the VUE creating function beforehand. The functions provided may include functions inside the VUE, functions in the CN and functions in the UE. The VUE Type C may have several CPFs, a database and a capability to obtain permitted network information.

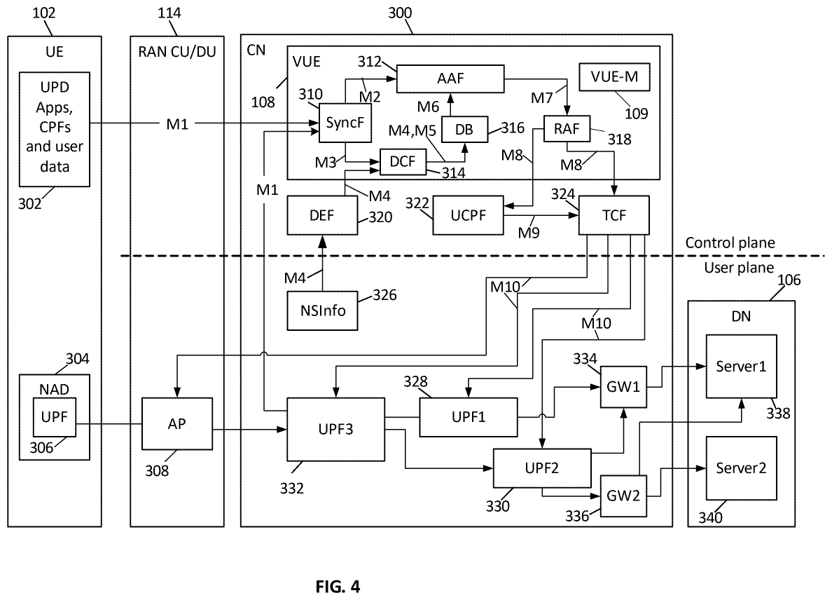

FIG. 4 shows an example of an operation framework with a VUE of type C in accordance with the present disclosure. In this example, the UE 102 wishes to establish a PDU session with a server (e.g., server1 338 or server2 340) in an external data network (DN) 106. The UCM service helps to route UE traffic through the network UPFs 328, 330, and 332 in order to meet the required QoS, required processing and cost by communicating with the network functions. FIG. 4 shows a block diagram of a UE 102, a DN 106, a RAN CU/DU 114 and a CN 300 coupled to each other. The UE 102 may include a user personal device (UPD) 302, which may have software and hardware components configured to process UE applications and personal data, and a network access device (NAD) 304, which may include network access components and a UPF 306. The RAN CU/DU 114 may include an access point (AP) 308. The UCM service may configured to provide the UE control over the UE traffic, control over the processing of data associated with the UE, and control over the NFs in the network. The control over the NFs in the network may include control over the NFs comprising Life Cycle Management (LCM) of NFs that may include at least one of instantiation, modification, NF resources scaling and a termination of NFs. The user personal data and the UE data may both be considered as user data and may be obtained from a user or from a user device by the VUE, after interacting with the user device or the user. UE data may include UE sensor data. User data may include the sensor data of the user devices and user information. Subsequent the interaction, the VUE may store some or all of the user data at a network store or share some or all of the user data with the network. In some embodiments, the network service may be a protocol data unit (PDU) session and the UE device may be configured to send a PDU session initiation indication to at least one of the at least one NF configured to be controlled by the UE; and control the network service in accordance with the at least one NF configured to be controlled by the UE.

The core network (CN 300) may include, in the control plane, the VUE 108. The VUE 108 may include a sync function (SyncF) 310, an analysis and action function (AAF) 312, a data collection function (DCF) 314, a database (DB) 316, and a routing assistance function (RAF) 318. The CN 300 may also include a data exposure function (DEF) 320, a UCM service policy function (UCPF) 322 and a traffic controller function (TCF) 324.

In the user plane, the CN 300 may include network state information (Nsinfo) 326, any number of user plane functions such as, for example, a first user plane function (UPF1) 328, a second user plane function (UPF2) 330, a third user plane function (UPF3) 332, and any number of gateways such as a first gateway (GW1) 334 and a second gateway (GW2) 336. The user plane functions may carry out routing traffic and specific processing of traffic. The gateway functions (GW1 and GW2) are the first point of processing for incoming traffic from external data networks and the last point of processing outgoing traffic to the external data networks. When handling incoming traffic, they would route traffic to desired destinations after marking the packets according their QoS categories to be used inside the MNO network. The outgoing gateways may mark the traffic according to the data network and traffic requirements according to the transport network.

The DN 106 may include any number of servers such as a first server (Server1) 338 and a second server (Server2) 340.

Using a sync channel, the UE 102, using the UPD 302, may send a message M1 to the SyncF 310 of the VUE 108 to initiate a PDU session between the UE 102 and a server (e.g., the server 338) in the DN 106 when the PDU session belongs to an already established UCM service. The message M1 may include a UCM service type and information on the data packet identification, QoS requirements, UE mobility information, application information, processing requirements, etc., which provide sufficient information to route or process traffic. The initiation request M1 message triggers initial preparation steps for the PDU session. In some embodiments, the initiation of the PDU session may happen when the UE 102 or a server (e.g., the server 338) in the DN 106 starts the transmission of the first packet belonging to a specific UCM service type for communication between the server and the UE 102. The packet header of the packet may contain the UCM_ServiceTypeID and the Core network UPF that receives the packet first may identify from this UCM_ServiceTypeID the start of the PDU session and inform the VUE 108 to start initial preparation steps. These steps may include the VUE 108 providing the UCPF 322 with policies for the requested PDU session UCM service (e.g., the policies may describe the type of technical features or type of routing and processing that is required for the service and how the dynamic changes are informed to the network functions). The UCPF 322 may instruct, using a message M9, the TCF 324 on how to interpret and carry out instructions received in a message M8, from the RAF 318. For example, the PDU session traffic may need to be sent to a particular server such as server1 338. In another example, the traffic may need to be passed through the UPF 2 330 and the GW 2 336 instead of the GW 1 334 since the other paths are overloaded or costly to be used. In another example, the traffic may need to be passed through a specific UPF such as UPF1 328 for special processing. In addition, the preparation steps may include the DCF 314 obtaining, in a message M4, initial network state information from the DEF 320 after the DEF 320 obtains, in a message M4, the network state information from the Nsinfo 326. In some embodiments, the network service may be a protocol data unit (PDU) session and the UE device may be configured to send a PDU session initiation indication to at least one of the at least one NF configured to be controlled by the UE; and control the network service in accordance with the at least one NF configured to be controlled by the UE.

The DEF 320 may be accessed through an API by the DCF 314 function of the VUE 108. The initial network information includes topology related information, e.g., network functions (NFs) with their processing capabilities such as processing functionality, current loading and network addresses, cost related information such as cost model for each path and features and network abstractions such as current loading of each potential traffic path or historical resource usage of different services at different geographical locations. It can also include RAN CU/DU 114 information such as a RAN abstraction, e.g., the distribution of signal strength received from different access points at different locations or a map-based information, e.g., user traffic distribution in the geographical area and information access protocols. This initial network information may reflect the current network state or a future network state. This initial network information may be provided by a network management plane as a part of a configuration, or informed by a CN CPF (e.g., the DEF 320). The initial network information may also configure future network information reporting from the network about the network states. Such configuration may indicate to the DEF the type of information needed, whether that information is sent based on a request made to DEF, whether the information is sent in specific time intervals or whether it should be sent due to a specific event, e.g., loading of a network path increased beyond a threshold or user traffic exceeds a certain threshold. DEF may instruct the network monitoring functions to carry out the necessary monitoring in accordance with the network information reporting requirements.

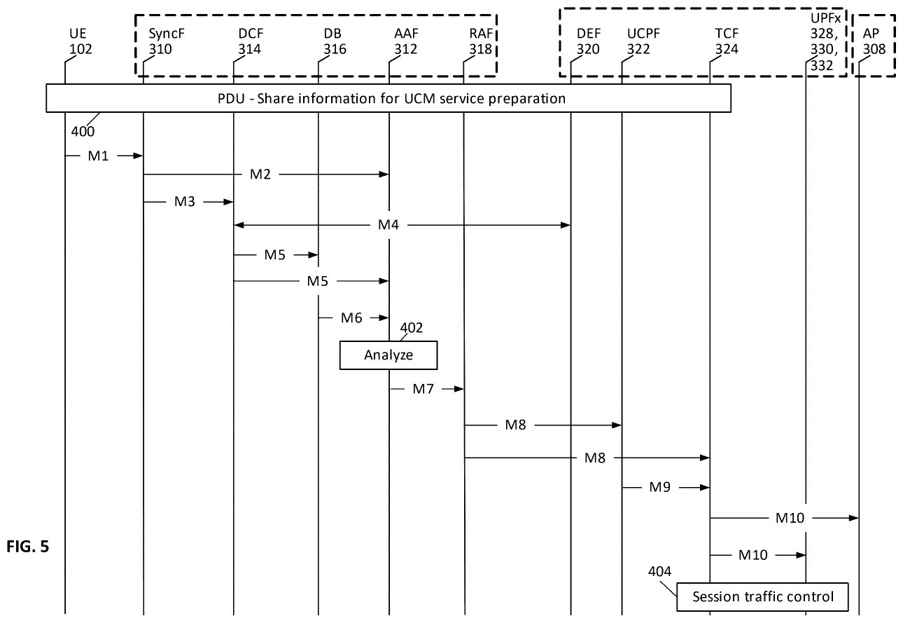

In accordance with the present disclosure, FIG. 5 shows an embodiment of a process flow for the messages M1, M2, M3, M4, M5, M6, M7, M8, M9 and M10 shown in FIG. 4.

M1 message—After generating a protocol data unit (PDU 400) and initiating of the protocol data unit (PDU 400), a PDU session belonging to the UCM service type, the UE 102 may send the M1 message to the SyncF 310 to inform the VUE 108 of a session initiation providing a UCM service type and of the state of the UE 102, the state of the UE 102 including, for example, mobility and location information. As indicated before, the M1 trigger message may also be sent by a network UPF by identifying a packet as belonging to a particular UCM service type using the UCM_ServiceTypeID in the packet header (not shown). In some embodiments, the network service may be a protocol data unit (PDU) session and the UE device may be configured to send a PDU session initiation indication to at least one of the at least one NF configured to be controlled by the UE; and control the network service in accordance with the at least one NF configured to be controlled by the UE.

M2 message—The SyncF 310 function may send the M2 message to the AAF 312 to request that the AAF 312 start an analysis process for the UCM service type. For this purpose, the AAF 312 may require information about current network state and current UE 102 mobility status. The required information may be provided by the information storage (DB 316) in the M6 message.

M3 Message—The SyncF 310 function may inform the DCF 314 about the session initiation by providing the DCF 314 with the UCM service type and the state of the UE 102 in the M3 message and sending the M3 message to the DCF 314.

M4 message—The DCF 314 may obtain, in the M4 message received from the DEF 320 the dynamic network information. This information may include monitoring the UE's traffic for quality information (QoS parameters such as delay), current network loading in different paths, available technical features for this location and proximity locations, the UE's traffic quality information, current cost information for different paths, future loading predictions in different paths etc.

M5 message—The DCF 314 may provide, in the M5 message, the updated UE 102 and network information to the DB 316, and it may also provide this data directly to the AAF 312.

M6 message—The AAF 312 may obtain the M6 message from the DB 316. The M6 message may include the current network and traffic information. Certain dynamic information may also be obtained directly by the AAF 312 from the DCF 314.

M7 message—The AAF 312 may analyze, at 402, the current network and the UCM session information and may decide to change the routing, priority, traffic processing functionalities or technical features used by the UCM service. If so, the AAF 312 may request the RAF 318 to take a suitable action by sending the M7 message to the RAF 318. The M7 message may include a policy change, a routing change, traffic priority changes, traffic QoS treatment method changes, technical feature changes, etc.

M8 message—The RAF 318 may request, in the M8 message, the UCPF 322 or the TCF 324 or both the UCPF 322 and the TCF 324, to perform policy changes for the UCM traffic control parameters such as technical feature selection, path selection, traffic priority, QoS requirements, etc. This may include instructions to either go though GW 1 334 or GW 2 336 or go through a specific UPF function such as UPF1 328.

M9 message—The UCPF 322 may determine new policies according to the RAF 318 information and update the UE traffic related policies at the TCF 324 by sending the new policies in the M9 message.

M10 message—The TCF 324 may inform, in M10, the UPFs (e.g., UPF1 328, UPF2 330 and UPF3 332) or the AP 308 about the required routing changes, technical feature changes or Core network has a function 404 to control session traffic paths.

When sending data or information through any of the above described messages, a request for information may be provided beforehand by the receiving function or automatic data transfer may be setup during the initial preparation step to update this information from time to time or when there is a change. Although some of the two-way communication steps are not shown in FIG. 4 or FIG. 5, it is to be understood that a prior arrangement or a prior request may be required prior to sending information from one point to another.

The TCF 324 may include a session management function for the network traffic (e.g., SMF in 5G system) and a policy control function for controlling policies of the network traffic (e.g., PCF in 5G). The TCF 324 may use these two functions to execute preferred routing paths, priorities, technical features, QoS for different flows and other traffic control related parameters. The UPFs (e.g., UPF1 328, UPF2 330 and UPF3 332) or the AP 308 may carry out the instructions according to the parameters provided by the TCF 324. In some embodiments the RAF 318 may directly contact the AP 315 or the UPFs (e.g., UPF1 328, UPF2 330 and UPF3 332) to provide these functions with the traffic controlling parameters.

Other embodiments of this disclosure directed to a method, an apparatus, and a system may allow a UE to control network services provided by a network. The UE may control the network services by a VUE instantiated in the network. The VUE represents the specific UE subscribed to the UCM services provided by the network.

FIG. 6 shows a flowchart of an embodiment of a method 500 in accordance with the present disclosure. The method 500 may be conducted by a network function module and may include broadcasting, at action 502, a list of VUE types or available UCM services and their associated costs or charging procedures. After receiving, at action 504, from a UE or an existing VUE, a subscription request for a VUE type or for UCM services, the method 500 may instantiate, at action 506, a VUE corresponding to the requested VUE type. Network functions and interfaces required for the VUE to control the UCM services may also be instantiated. After receiving, at action 508, a trigger for the start of a UCM service, the method 500 may further include, optionally, activating the VUE, at action 510, and operating the VUE, at action 512, to control the UCM services.

Receiving, at action 504, a subscription request for the UCM services may be followed by receiving a trigger from a UE with the trigger identifying the UE and hosting network, e.g., a mobile network operator (MNO), authenticating and authorizing the operation based on the subscription. The requested VUE type may be instantiated by the hosting network or the VUE platform functionality. The instantiation of the VUE type may comprise the instantiation of at least one NF belonging to the VUE type and its required interfaces. In some embodiments, the instantiation of the VUE type may include the instantiation of a VUE-M, which has the capability of instantiating other NFs and interfaces associated with the VUE type. In some embodiments, instantiating the VUE may include instantiating NFs and respective interfaces associated with a VUE type. The hosting network or the VUE-M may instantiate more network functions inside the VUE and control and manage them with associated interfaces and policy modifications. Instantiation of the network functions may include instantiation of control plane functions, user plane functions, database management functions, and database recording functions. Instantiation of user plane functions (UPFs) may be required for a set of particular user cases.

FIG. 6 shows a block diagram of an electronic device 600 which may represent a user equipment (UE) or a network node. A computer equipped with network function may be configured as the electronic device 600. Such an electronic device may correspond to parts of a network node providing network access (e.g., a gNB). The electronic device 600 may perform any or all of operations of the above methods and features explicitly or implicitly described herein, according to different embodiments of the present disclosure.

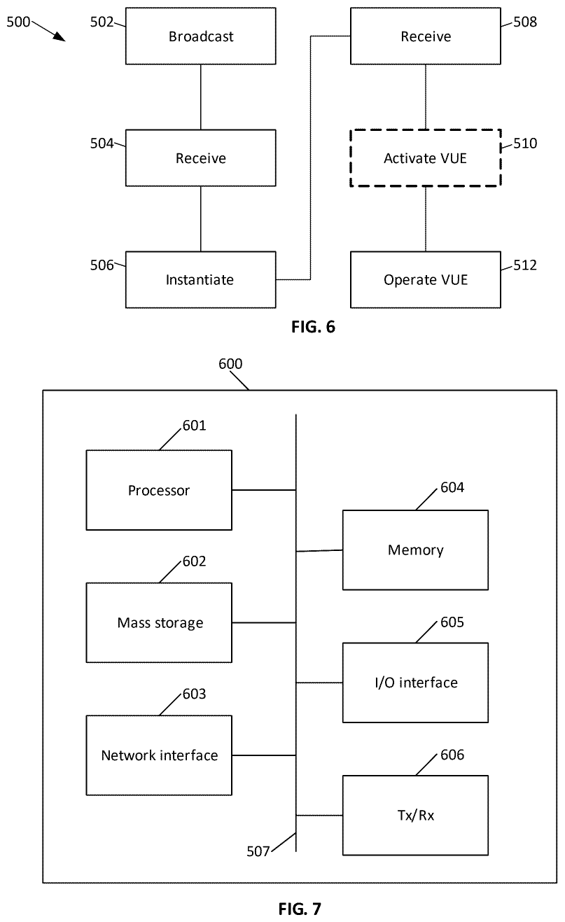

As shown if FIG. 7, the device includes a processor 601, such as a Central Processing Unit (CPU) or specialized processors such as a Graphics Processing Unit (GPU) or other such processor unit, a memory 604, a non-transitory mass storage 602, an I/O interface 605, a network interface 603, and a transceiver 606, all of which are communicatively coupled via bi-directional bus 607. According to certain embodiments, any or all of the depicted elements may be utilized, or only a subset of the elements may be utilized. Further, the device 600 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 604 may include any suitable type of non-transitory memory such as static random access memory (SRAM), dynamic random access memory (DRAM), synchronous DRAM (SDRAM), read-only memory (ROM), any combination of such, or the like. The mass storage element 602 may include any suitable type of non-transitory storage device, such as a solid state drive, a hard disk drive, a magnetic disk drive, an optical disk drive, a USB drive, or any computer program product configured to store data and machine executable program code. According to certain embodiments, the memory 604 or the mass storage 602 may have recorded thereon statements and instructions executable by the processor 601 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the implementations as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Actions associated with the method described herein can be implemented as coded instructions in a computer program product. In other words, the computer program product is a computer-readable medium (a tangible, non-transitory computer readable medium or memory) upon which software code (instructions) is recorded to execute the method when the computer program product is loaded into memory and executed on the microprocessor of a wireless communication device, or a network device, or a user equipment device.

Further, each operation of the method may be executed on any suitable computing device, such as a personal computer, server, personal digital assistant, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. For example, although some embodiments of the disclosure provide for the VUE, instantiated inside the core network, the VUE may be instantiated inside RAN with similar functions in which case control plane and user plane functions used for the core network may be instantiated inside RAN with similar functionalities. The specification and drawings are, accordingly, to be regarded simply as an illustration of the implementations as defined by the appended claims, and are contemplated to cover any and all modifications, variations, combinations or equivalents that fall within the scope of the present application.

What is claimed is:

1. A method for a user equipment (UE) to control a network service obtained from a network, the method comprising:
receiving, by a control, management, and operation (CMO) function module instantiated in the network, from the UE, a request for the UE to control the network service offered by the network;
in response to the request, instantiating, by the CMO function module, at least one network function (NF) configured to be controlled by the UE; and
configuring, by the CMO function module, the at least one NF to control the network service in accordance with instructions received from the UE.

2. The method of claim 1, further comprising, by the CMO function module:
indicating to the UE that the UE controls the network service.

3. The method of claim 1, further comprising, by the CMO function module:
instantiating an NF module defining a virtual UE (VUE), the VUE comprising the at least one NF.

4. The method of claim 1, wherein:
the UE is controlled by a user at the UE or a user application running at the UE; and
the at least one NF is configured to receive instructions from the UE in accordance with input provided by the user at the UE or by the user application running at the UE.

5. The method of claim 1, wherein:
the at least one NF is configured to coordinate with the CMO function module to control the network service.

6. The method of claim 3, wherein the network is configured to perform at least one of the following operations:
providing to the UE, software configured to communicate with the VUE;
providing authentication keys to the UE and to the VUE to enable secure communication between the UE and the VUE;
providing a procedure for the UE to control the network service, the procedure defining how to establish a communication session for the network service;
providing identifiers to be used by the CMO function module to identify messages associated to a control of the network service; or
providing addresses of functions with which the UE has to communicate to control the network service.

7. The method of claim 3, wherein the network comprises a trusted execution environment (TEE) within which the VUE operates, wherein the VUE is isolated from the network, and permission to access the at least one network function and data inside the TEE is controlled by the VUE according to an access policy.

8. The method of claim 3, wherein the VUE has at least one VUE policy that defines how the VUE and the at least one network function operate, the at least one VUE policy being based on one or more of:
a UE policy set by a user of the UE or by a user application running at the UE;
privacy schemes provided by the network;
an access policy defining a permission to access the functions and data inside the VUE; or
network environment information comprising one or more of:
network privacy preserving methods;
information about network functions inside the CMO function module;
a network topology; or
a charging method to charge for network services.

9. The method of claim 3, wherein:
the CMO function module includes a VUE creation function (VUCF); and
the request for the UE to control the network service is received at the VUCF and provided by the VUCF to an orchestrator configured to generate the VUE.

10. The method of claim 9, wherein:
the function module includes a life cycle management (LCM) function configured to:
request instantiation, modification, and termination of the VUE from an orchestrator; and
receive, from the orchestrator, a message indicating to the VUE that the request has been executed.

11. The method of claim 3, wherein the at least one NF is configured to coordinate with the VUE and take actions in accordance with requests made by the VUE to control the network service.

12. The method of claim 1, wherein the at least one NF is configured to operate as at least one of:
a control plane function;
a user plane function;
a data storage function; or
a computing facilities function.

13. The method of claim 1, wherein the at least one NF is further configured to perform at least one of the following operations:
authenticating the UE;
authorizing on behalf of the UE;
interacting with the UE to obtain a user context;
controlling user traffic;
obtaining the user traffic or user data for internal processing;
controlling access to the at least one NF and data associated with a virtual UE (VUE);
interacting with the UE to obtain the user data;
storing at least a portion of the user data;
sharing at least a part of the user data with the network; or
controlling or managing other NFs in the VUE.

14. The method of claim 3, wherein the UE, through the VUE, controls the network service, the network service including at least one of:
a UE traffic service based on a user traffic policy;
a data processing service of data associated with the UE; and
a life cycle management (LCM) service of the at least one NF inside the CMO function module, the LCM service including at least one of an instantiation of the at least one NF, a scaling of NF resources used by the at least one NF, or a termination of the at least one NF.

15. The method of claim 3, wherein:
the network comprises a core network having core NFs; and
the VUE is configured to control the core NFs, the core NFs including at least one of: a routing function, a data processing function, or a traffic forwarding function.

16. A non-transitory computer readable storage medium comprising instructions that, when executed by one or more processors, cause the one or more processors to perform operations comprising:
receiving, from a user equipment (UE), a request for the UE to control a network service offered by a network;
in response to the request, instantiating at least one network function (NF) configured to be controlled by the UE; and
configuring the at least one NF to control the network service in accordance with instructions received from the UE.

17. A network node having a control, management, and operation (CMO) function module defined thereat, the network node being part of a network, the network node comprising:
at least one processor; and
at least one memory storing instructions that, when executed by the at least one processor, cause the at least one processor to perform operations comprising:
receiving, from a user equipment (UE), a request for the UE to control a network service offered by a network;
in response to the request, instantiating at least one network function (NF) configured to be controlled by the UE; and
configuring the at least one NF to control the network service in accordance with instructions received from the UE.

18. The network node of claim 17, wherein the operations further comprise:
indicating to the UE that the UE controls the network service.

19. The network node of claim 17, wherein the operations further comprise:
instantiating a NF module defining a virtual UE (VUE), the VUE comprising the at least one NF.

20. The network node of claim 17, wherein:
the UE is controlled by a user at the UE or a user application running at the UE; and
the at least one NF is configured to receive instructions from the UE in accordance with input provided by the user at the UE or by the user application running at the UE.
